(19) United States
(12) Patent Application Publication
(10) Pub. No.: US 2010/0312471 A1
(43) Pub. Date: Dec. 9, 2010

(54) GLOBAL POSITIONING SYSTEM TERMINAL DEVICE AND NAVIGATION METHOD THEREOF

(75) Inventor: CHIH-WEI CHENG, TAIPEI COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignees: Inventec Appliances (Shanghai) Co., Ltd., Shanghai City (CN); INVENTEC APPLIANCES CORP., TAIPEI COUNTY (TW)

(21) Appl. No.: 12/795,696

(22) Filed: Jun. 8, 2010

(30) Foreign Application Priority Data
Jun. 8, 2009 (CN) 200910146469.5

(51) Int. Cl. G01C 21/26; G06K 9/00

(52) U.S. Cl. 701/208; 382/107

(57) ABSTRACT

The present invention relates to a navigation method. The navigation method provides a navigation display while a GPS terminal device is moving along a road with a traffic marking marked thereon and when GPS information is not available. The navigation method captures a plurality of images comprising the road image with traffic markings and calculates a time of the GPS terminal device passing by the end points of the traffic marking. Then, the moving velocity is computed by using the time as divisor and the unit line as dividend. The navigation method utilizes a GPS terminal device comprising an image capture unit and a timer. The image capture unit captures images and the timer calculates the time.

### FIELD

The present invention relates to a global positioning system (GPS) terminal device. More specifically, the present invention relates to a GPS terminal device and a navigation method for assisting navigation by providing a navigation display to maintain continuous navigation when GPS information is not available.

### BACKGROUND

The Global Positioning System (GPS) is a space technique developed by the US military. The GPS provides reliable 3D positioning and navigation to worldwide users anywhere on or near the Earth which has an unobstructed view of four or more GPS satellites by calculation thereof. The GPS has the advantages of rendering the highly efficient worldwide and 24/7 service.

Many civilian applications benefit from the GPS technique. Besides synchronizing clocks, performing as an aid to engineering or as a surveying tool, the most common application in daily life is the vehicle navigation. First of all, a GPS navigation device is installed in the vehicle to receive the GPS positioning information. Then the precise positioning and movement information can be rendered in real time through the pre-stored map information and navigation software. Therefore, the driving experience can be improved and the inconvenience of searching on the maps can be avoided.

Notwithstanding having many advantages, GPS navigation methods still have some limits. Except the temporary malfunction of the satellites, the effect of solar wind, atmosphere concentration, building block, and hindrance, such as tunnel, bridge, or parking lot, may cause determination interruption or miscalculation.

The following three approaches are usually taken to solve the aforementioned problems: the first approach is enhancing reception ability; the second approach is temporarily substituted by the Dead Reckoning (DR) technique; and the third approach is correcting errors of the GPS by disposal of reference stations.

With the approach to enhance reception ability, the TW 1271535 patent, entitled “GPS antenna adjusting system and method thereof/GPS satellite signal strength display module and method thereof”, discloses satellite signal strength data generated for adjusting the antenna so as to improve the reception of the signal.

With the approach of the Dead Reckoning technique, the navigation system is automatically switching to the assistance navigation mode when the signal is interrupted. The moving velocity of the vehicle can be obtained by the wheel rotation transducer and the pre-stored map information to trace the user's position and to maintain navigation.

With the approach to correcting errors of the GPS by disposal of reference stations, Differential GPS (DGPS) is typically used. The DGPS corrects GPS errors by the disposal of the GPS reference stations and then broadcasts the real time value to the user within the signal transmitting area so as to correct the errors. For example, the TW 1227332 patent, entitled “device calibrating GPS/DGPS positioning deviation and eliminating hindrance effect and method thereof”, illustrates a short range communication to improve the accuracy to at least 98%.

With the approaches, comparing to the higher equipment requirement, the DR is widely developed and researched by the firms in the business because the compatibility in spite of the lower accuracy. However, the wheel rotation velocity transducer applied in the DR technique will cause errors of the velocity calculation under the following circumstances: wheel sliding, the tire radius variation caused by the tire pressure or by the erosion by the tire itself, and the transducer contamination etc.

It is therefore believed that inconvenience and deficiency exist in the GPS navigation technique, and need to be further improved. To solve the aforementioned existing problems, people skilled in the art are trying to find the perfect solution, but proper design have not been developed and there is no corresponding solution to solve the aforementioned problems, which is a long felt need. Hence, providing an innovate velocity computing method to assist navigation is an important research topic and is the goal need to be achieved.

The present invention renders an alternate solution regarding to the deficiency of the wheel transducer to determine the moving velocity.

### SUMMARY

The object of the present invention is to overcome the problem of navigation interruption in the existing navigation technique, the problem is caused by the temporary malfunction of the GPS satellite, object hindrance or interference, and the like. The object of the present invention provides a new navigation method and GPS terminal device thereof and provides the velocity computing information in an assisting inertia GPS navigation system while the GPS navigation signal is interrupted. These technical means are very practical.

In accordance with the object of the present invention and the means solving problems, the present invention provides a GPS terminal device providing a navigation display when the GPS terminal device is moving along a road with a traffic marking marked thereon and when GPS information is not available. The GPS terminal device comprises a storage unit, an image capture unit, a timer, and a processing module electrically connecting to the storage unit, the image capture unit, and the timer. The storage unit stores at least one map information; the image capture unit captures a plurality of images comprising the road image with the traffic marking thereon when the GPS terminal device moving along the road; the timer calculates a time for the GPS terminal device passing the traffic marking; and the processing module computes a moving velocity according to the road images and the time, and renders the navigation display according to the map information and the moving velocity.

The object of the present invention can also be implemented with the following technical means.

In the aforementioned GPS terminal device, the processing module comprises an image computing module to compute the moving velocity according to the images comprising the road and the time.

In the aforementioned GPS terminal device, the image computing module comprises an image determining program.

In the aforementioned GPS terminal device, the image computing module comprises a velocity computing program.

In the aforementioned GPS terminal device, the traffic marking comprises at least one solid line.

In the aforementioned GPS terminal device, the traffic marking is a lane line.

In the aforementioned GPS terminal device, the image capture module comprises a charge coupled device (CCD).

In the aforementioned GPS terminal device, the GPS information is transmitted in compliance with the protocol defined by National Marine Electronic Association 0183 (NMEA 0183).

The aforementioned GPS terminal device further comprises a display unit to present the navigation display.

In accordance with the object of the present invention and the means solving the problems, the present invention provides a GPS terminal device providing a navigation display when the GPS terminal device is moving along a road with a traffic marking marked thereon and when GPS information is not available. The navigation method comprises the following steps of: (a) storing at least one map information; (b) capturing a plurality of images comprising the road image with the traffic marking while the GPS terminal device moves along the road with the traffic marking; (c) calculating a time of the GPS terminal device passing a unit line of the traffic marking; (d) computing a moving velocity according to the time and the unit line on the images; and (e) generating the navigation display according to the map information and the moving velocity.

The object of the present invention can also be implemented with the following technical means.

In the aforementioned navigation method, the traffic marking is a lane line.

In the aforementioned navigation method, the step (c) further comprises the step (c0) of identifying at least one end point of the unit line of the images so as to calculate the time according to a starting time and an ending time.

In the aforementioned navigation method, the step (d) further comprises the step (d0) of defining a length of the unit line according to markings and signals based on the rule of regional traffic systems.

In the aforementioned navigation method, the step (d) further comprises the step (d1) of defining a proportional scale with respect to the plurality of images so as to compute the moving velocity by a shifting length of the unit line in the images.

The present invention has significant advantages and effects over the existing technical means. From the aforementioned description, the present invention provides a GPS navigation terminal device to achieve the aforementioned objects. The navigation terminal device comprises a storage unit, an image capture unit, a timer, and a processing module. When the GPS navigation terminal device can not effectively receive a GPS positioning information, the road images can be captured automatically and time of the user passing the traffic marking can be calculated by identifying one end of the traffic marking. Alternatively, the time is defined and the shifting length is determined by identifying the ends of the traffic marking. The length or the shifting length of the traffic marking both can represent a moving distance of the user. The processing module divides the moving distance by the time to have a velocity and provides the navigation images accordingly.

By the aforementioned techniques, the navigation method in accordance with the present invention comprises at least one of the following advantages and effects:

1. Comparing to the conventional GPS navigation system, the present invention comprises a storage unit, an image capture unit, a timer, and a processing module, so driver's velocity information can be determined by capturing the road surface image and the GPS interruption caused by hindrances can be effectively solved. Even suffering from the bad weather, hindrance above, or GPS navigation malfunction, the driver can still obtain position and moving direction by combining the velocity result computed from the present invention with the pre-stored map information. Thus the navigation accuracy can be improved and the driving safety can be assured.

2. Comparing to the conventional wheel rotary speed transducer in the DR technique, the present invention avoids the transducer determination fail under the situation of the slipped wheel, the tire radical change caused by the tire pressure or tire worn down, and the transducer damage.

3. Lastly, comparing to DGPS technique, the cost of the present invention can be largely reduced and thus the present invention can be widely adopted.

To conclude, the present invention relates to a navigation method. The navigation method captures a plurality of images comprising the road image with traffic markings and calculates a time passing the'end points of the traffic marking while a GPS terminal device is moving along a road with a traffic marking marked thereon and when GPS information is not available. Then, the moving velocity is computed by using the time as divisor and the unit line as dividend, and the navigation display is constantly provided accordingly. The navigation method utilizes a GPS terminal device comprising an image capture unit and a timer. The present invention has the cutting edge technique and obvious effect, and is a novel, advanced, and utilized new design.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a schematic view of a GPS navigation system combining a vehicle to accomplish navigation technical means in accordance with one embodiment of the present invention;

FIG. 2 illustrates a block diagram in accordance with one embodiment of the present invention;

FIG. 3 illustrates a schematic view of a vehicle entering a hindrance area and driven on a road with straight lines in accordance with one embodiment of the present invention;

FIG. 4 illustrates a schematic view that an image capture unit captures road images in accordance with one embodiment of the present invention;

FIGS. 5, 5A, and 5B are schematic views that the image determination program determines the road images captured in sequence in accordance with the first preferred embodiment of the present invention;

FIGS. 6 and 6A are schematic views that the image determining program determines the road images captured in sequence in accordance with the second preferred embodiment of the present invention;

FIG. 7 is a flow chart in accordance with the first preferred embodiment of the present invention;

FIG. 8 is a flow chart in accordance with the first preferred embodiment of the present invention; and

FIG. 9 is a flow chart in accordance with the second preferred embodiment of the present invention.

### DETAILED DESCRIPTION

Exemplary embodiments of the present invention are described herein in the context of a GPS terminal device and a navigation method. Reference will now be made in detail to implementations of the exemplary embodiments as illustrated in the accompanying drawings.

Those of ordinary skilled in the art will realize that the following detailed description of the exemplary embodiments is illustrative only and is not intended to be in any way limiting. Other embodiments will readily suggest themselves to such skilled persons having the benefit of this disclosure.

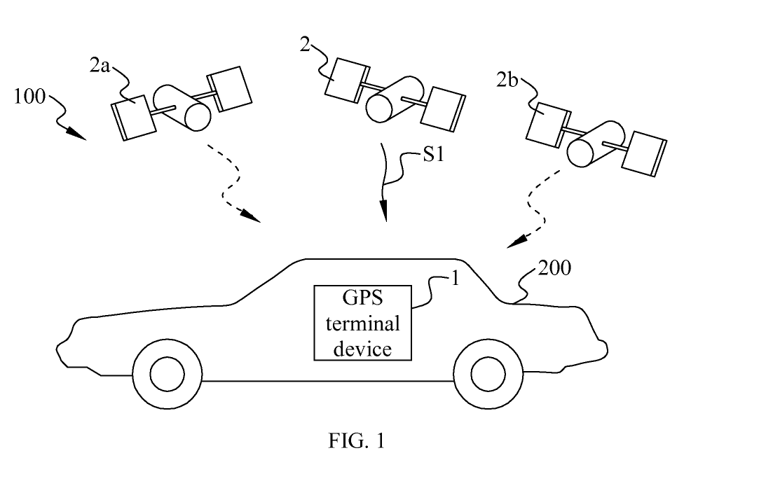

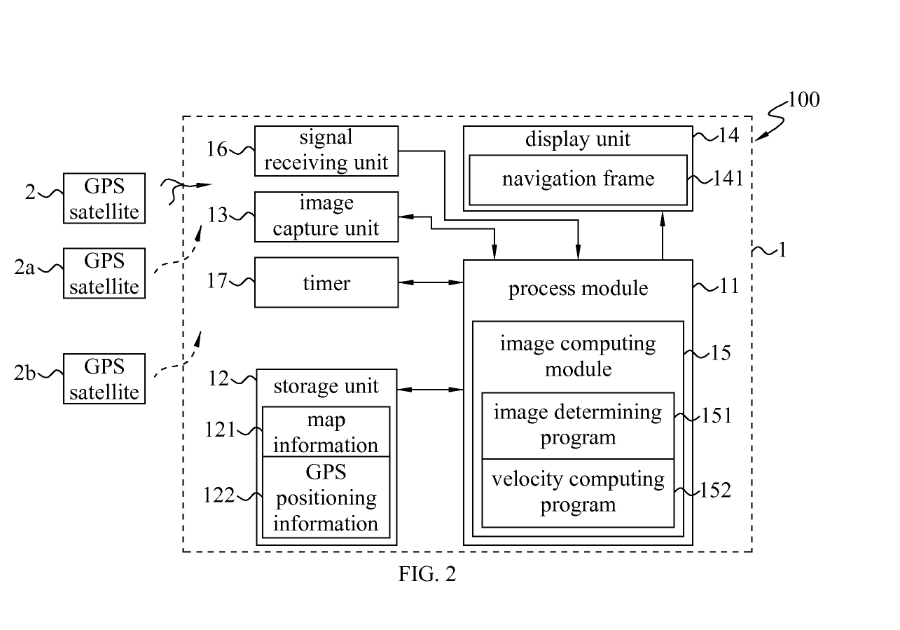

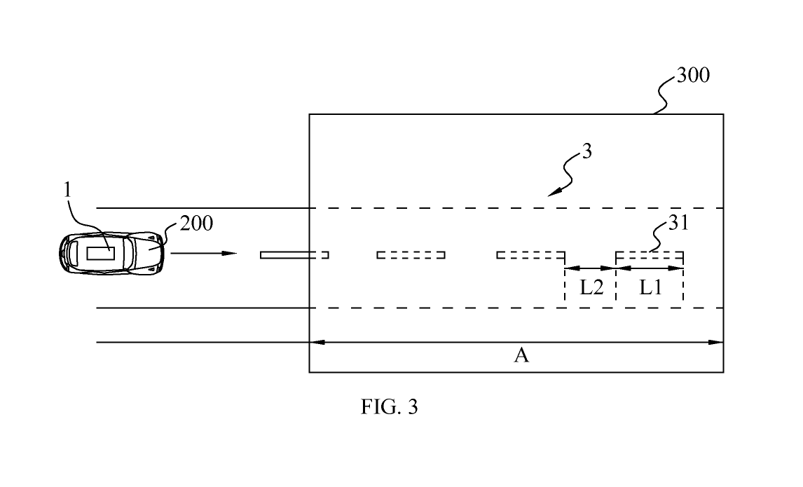

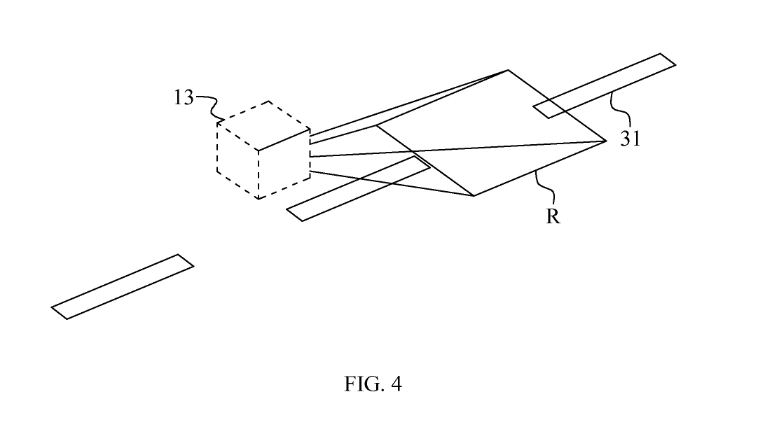

Please refer to FIG. 1 to FIG. 4. FIG. 1 is a schematic view of a GPS navigation system combining a vehicle to accomplish navigation technical means. FIG. 2 is a block diagram in accordance with one embodiment of the present invention. FIG. 3 is a schematic view of a vehicle entering a hindrance area and driven on a road with straight lines in accordance with one embodiment of the present invention. FIG. 4 is a schematic view that an image capture unit captures road images in accordance with one embodiment of the present invention.

A Global Positioning System (GPS) navigation system 100 comprises a GPS navigation terminal device 1 and three GPS satellites (2, 2a, and 2b). The GPS navigation system terminal device 1 is installed on a vehicle 200 and the GPS satellite 2 constantly transmits positioning signal S1 to the earth.

The GPS terminal device 1 comprises a processing module 11, a storage unit 12, an image capture unit 13, a display unit 14, an image computing unit 15, a signal receiving unit 16, and a timer 17. The processing module 11 comprises the image computing unit 15. Besides, the storage unit 12, the image capture unit 13, the display unit 14, the signal receiving unit 16, and the timer 17 are electrically connected to the process module 11 respectively, and the image capture unit 13 may be a charge coupled device (CCD). Further, the storage unit 12 pre-stores at least one map information 121.

As shown in FIG. 3, the signal receiving unit 16 may receive GPS positioning signal S1 under normal navigation status to receive the GPS position information 122 in the GPS positioning signal S1. Moreover, the GPS positioning signal S1 may usually be transmitted in compliance with the protocol defined by National Marine Electronic Association 0183 (NMEA 0183).

When a driver (not shown) drives vehicle 200 onto a road A and in the hindrance area of an obstacle 300, the signal receiving unit 16 is not able to receive the GPS positioning signal S1 and the normal navigation status will be forced to interrupt. The road A comprises a traffic marking 3, which is a dot line and comprises at least one unit line 31, the length L1 of the unit line 31 is four meters, and the length L2 of the interval is six meters, however, it is should be noted that the length L1 and L2 are not limited thereto. At this time, an assisting navigation status will be entered.

As shown in FIG. 4, when the GPS terminal device 1 enters the assisting navigation status, the image capture unit 13 is actuated and captures the road images of the road A as a plurality of road images 18 according to an image capture range R. Also, the image capture range R comprises traffic marking 3.

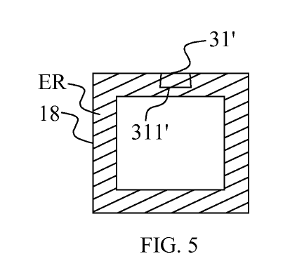

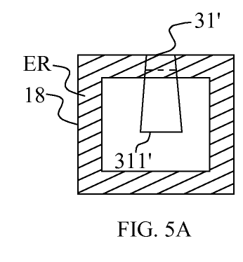

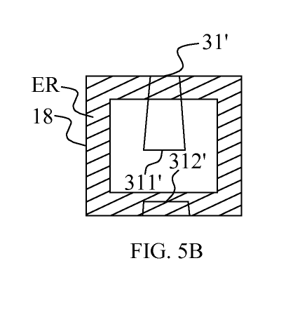

Following please refer to FIGS. 5, 5A and 5B, which are schematic views that the image determining program determines the successively captured road images in accordance with the first preferred embodiment of the present invention. The road images 18 are transmitted to the image computing module 15. The image determining program 151 defines an end point identification range ER on the margin of the road images 18, the first end point 311′ and the second end point 312′ of the unit line 31′ of the traffic marking 3′. As shown in FIG. 5, if the first end point 311′ is located in the end point identification range ER and near the top margin of the road image 18, then the vehicle 200 is approaching the unit line 31 and the image determining program 151 defines a starting time for the timer 17 to capture accordingly. As shown in FIG. 5A, if the first end point 311′ is located outside the end point identification range ER, then the image determining program 151 does not take action. As shown in FIG. 5B, if the second end point 312′ is located in the end point identification range ER and approaches the bottom margin of the road images 18, then the vehicle 200 is about to pass the unit line 31 and the image determining program 151 defines an ending time for the timer 17 to capture accordingly. The tinier 17 calculates a time by capturing the starting time and the ending time, and the time represents the duration that the vehicle 200 passing the unit line 31.

Then the time is transmitted back to the image computing module 15. The velocity computing program 152 divides the length L1 of the unit line 31 by the time to obtain a moving velocity. A navigation display 141 is generated by computing the combination of the moving velocity and the map information 121 and is presented in the display unit 14. In addition, the length L1 of the unit line 31 may be defined by the R.O.C. traffic signs, marking, and lights rule.

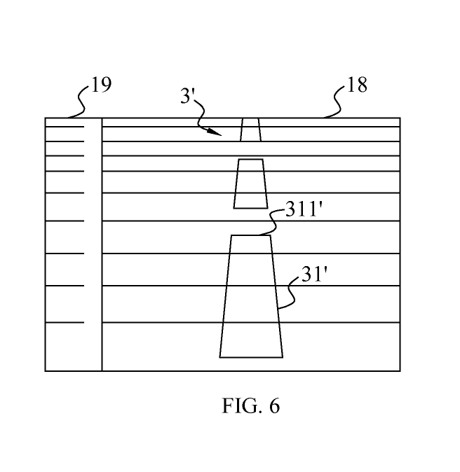

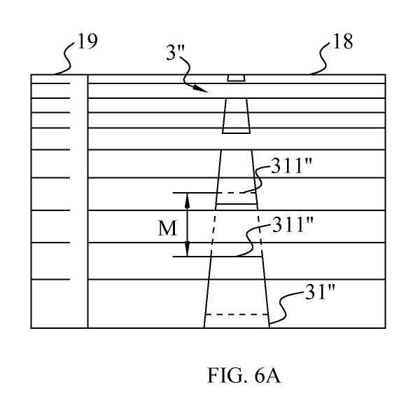

Please refer to FIG. 6 to FIG. 6A, which are schematic views that the image determining program determines the road images captured in sequence in accordance with the second preferred embodiment of the present invention, and also refer to FIG. 2 and FIG. 3. The timer 17 defines a time for the image capture unit 13 to use as capture interval to capture the road surface of the road A as road image 18. Besides, the road images 18 comprise traffic markings 3. Following the road image 18 is transmitted to the image computing module 15. The image determining program 151 defines a scale 19 in compliance with the perspective principle when the capture ratio and focus of the image capture unit 13 are fixed. The image determining program 151 divides the road images 18 according to the scale 19 for further identification and determination. At this time, as shown in FIG. 6, the image determining program 151 identifies the first end point 311′ of the unit line 31′ in the road images 18. As shown in FIG. 6, the image determining program 151 identifies the first end point 311″ of the unit line 31″ and determines a shifting length M of the distance from the first end point 3.11′ to the first end point 311″ in a time. Following the image determining program 151 computes the shifting length M to obtain an actual shifting (not shown) according to the scale 19. The velocity computing program 152 divides the actual shifting by the time to obtain the moving velocity. The moving velocity is computed with map information 121 to generate a navigation display 141 and display the navigation display 141 on the display unit 14.

Then, to further elaborate the techniques disclosed in the present invention, the techniques disclosed in the first preferred embodiment and the second preferred embodiment are compiled as simple flow charts for people skilled in the art to memorize.

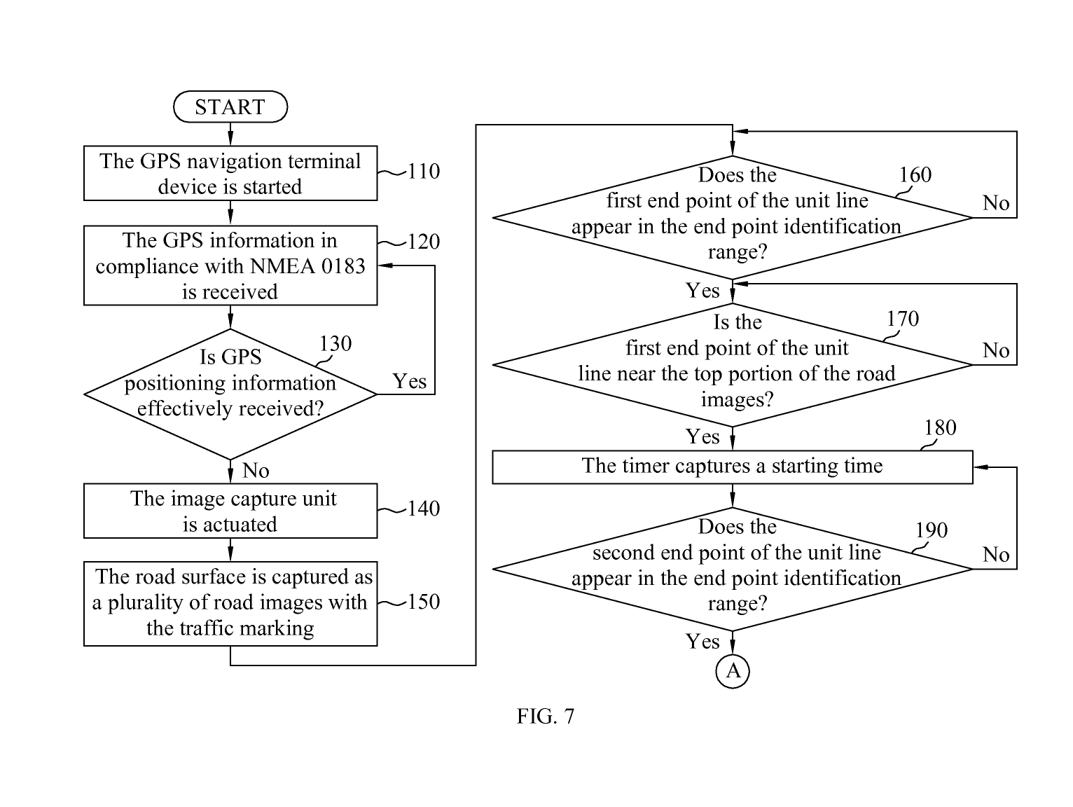

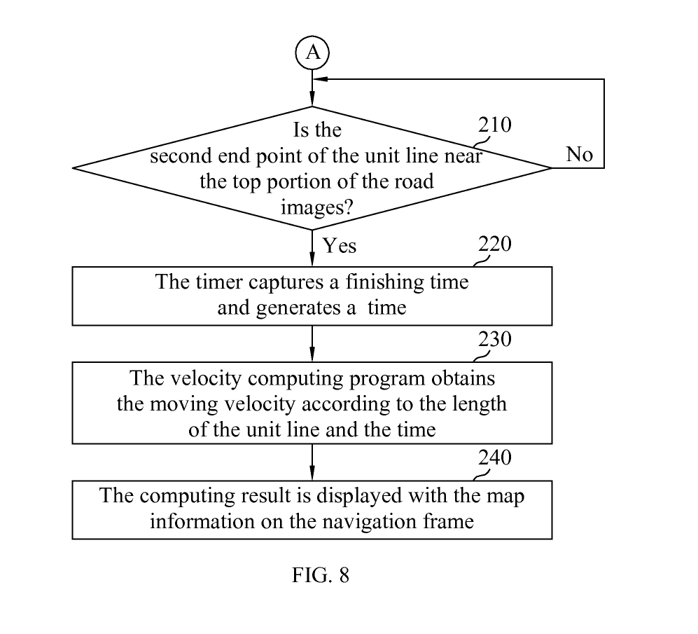

Please refer to FIG. 7 and FIG. 8, which are the flow charts of the first preferred embodiment, with FIG. 2. To accomplish the means of the present invention, the GPS navigation terminal device 1 must be started for entering into the GPS navigation system 100 (step 110). Following the signal receiving unit 16 receives the GPS positioning signal S1, which is transmitted in compliance with the NMEA 0183 protocol, to obtain the GPS positioning information 122 thereof (step 120). At this time, GPS navigation terminal device 1 determines whether the signal receiving unit 16 can effectively receive GPS positioning information S1 (step 130). If no, the GPS navigation terminal device 1 automatically actuates the image capture unit 13 (step 140), then captures the road surface with the traffic marking 3 as a plurality of road images 18 with the traffic marking 3 (step 150).

Subsequently, the image determining program determines whether the first end point 311′ of the unit line 31′ of the traffic marking 3′ in the road images 18 appears in the end point identification range ER (step 160). If yes, the image determining program 151 further determines whether the first end point 311′ is near the top portion of the road images 18 (step 170). If yes, the image determining program 151 generates a starting time for the tinier 17 to capture (step 180).

After the tinier 17 captures the starting time, the image determining program 151 continuously determines whether the second end point 312′ of the unit line 31′ of the traffic marking 3′ in the road image 18 appears in the end point identification range ER (step 190). If yes, the image determining program 151 further determines whether the second end point 312′ is near the bottom portion of the road images 18 (step 210). If yes, the image determining program 151 generates a finishing time for the timer 17 to capture. After the timer 17 receives the finishing time, a time will be generated. (step 220). The velocity computing program 152 divides the length L1 of the unit line 31 by the time to obtain the moving velocity (step 230). Lastly, the computing result can be displayed with the map information 121 on the navigation display 141 (step 240).

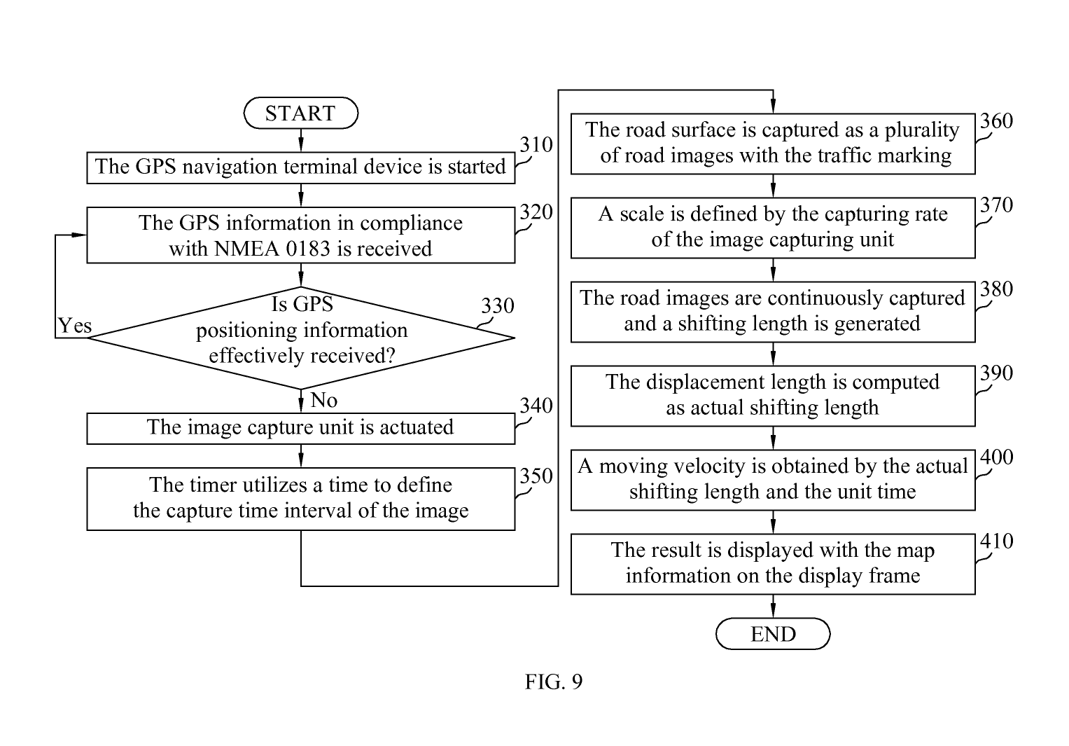

Please refer to FIG. 9, which is the flow chart of the second preferred embodiment, with FIG. 2. In the second preferred embodiment, the GPS navigation terminal device 1 must be actuated to enter into the GPS navigation system 100 (step 310). Following the signal receiving unit 16 receives the positioning signal S1, which is in compliance with the NMEA 0183 protocol, to obtain the GPS positioning information 122 thereof (step 320). At this time, GPS navigation terminal device 1 determines whether the signal receiving unit 16 can effectively receive the GPS positioning signal S1 (step 330). If no, the GPS navigation terminal device 12 automatically actuates the image capture unit 13 (step 340).

At this time, the timer utilizes a time to define the capture time interval of the image capture unit 13 (step 350). The image capture unit 13 uses the time as time interval to continuously capture the road surfaces as road image 18 wherein the road images 18 comprises the traffic marking 3 (step 360). The image determining program 151 defines a scale 19 by the capturing rate of the image capturing unit 13 (step 370). Then, the image determining program 151 identifies the end point 311′ and end point 311″ of the unit line 31′ in the continuously captured road images 18, and generates a shifting length M (step 380). In step 390, the image determining program 151 computes the shifting length M as actual shifting length (not shown). The velocity computing program 152 divides the actual shifting length (not shown) by the time to obtain the moving velocity (step 400). Lastly, the computing result can be displayed with the map information 121 on the display 141 (step 410).

People with general skill in the art would easily understand that, comparing to the conventional GPS navigation system, the terminal device 1 in present invention comprises an image capture unit, a timer, and an image computing module 15, so the driver's moving velocity can be determined by capturing the road images and the GPS navigation interruption caused by the hindrance 300 can be effectively solved. Even suffering from the bad weather, hindrance above, or GPS navigation malfunction, the driver can still obtain position and moving direction by combining the velocity result computed from the present invention with the pre-stored map information. Moreover, comparing to the conventional wheel rotary speed transducer in the DR technique, the present invention avoids the transducer determination fail under the situation of the slipped wheel, the tire radical change caused by the tire pressure or tire worn down, and the transducer damage. Thus the navigation accuracy can be improved and the driving safety can be assured

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. A global positioning system (GPS) terminal device, for providing a navigation display when the GPS terminal device is moving along a road with a traffic marking marked thereon and when GPS information is not available, the GPS terminal device comprising:
a storage unit, storing at least one map information;
an image capture unit, capturing a plurality of images comprising the road with the traffic marking on the GPS terminal device moving along the road;
a timer, calculating a time of the GPS terminal device passing by the traffic marking; and
a processing module, electrically connecting with the storage unit, the image capture unit, and the timer to compute a moving velocity according to the images comprising the road and the time and to render the navigation display according to the map information and the moving velocity.

2. The GPS terminal device as claimed in claim 1, wherein the processing module comprises an image computing module to compute the moving velocity according to the images comprising the road and the time.

3. The GPS terminal device as claimed in claim 2, wherein the image computing module comprises an image determining program to identify the traffic marking in the images.

4. The GPS terminal device as claimed in claim 2, wherein the image computing module comprises a velocity computing program to compute the time.

5. The GPS terminal device as claimed in claim 1, wherein the traffic marking comprises at least one solid line.

6. The GPS terminal device as claimed in claim 1, wherein the traffic marking is a lane line.

7. The GPS terminal device as claimed in claim 1, wherein the image capture module comprises a charge coupled device.

8. The GPS terminal device as claimed in claim 1, wherein the GPS information is transmitted in compliance with the protocol defined by National Marine Electronic Association 0183 (NMEA 0183).

9. The GPS terminal device as claimed in claim 1, further comprising a display unit to present the navigation display.

10. A navigation method for providing a navigation display while a GPS terminal device is moving along a road with a traffic marking marked thereon and when GPS information is not available, the navigation method comprising the following steps of:
(a) storing at least one map information;
(b) capturing a plurality of images comprising the road with the traffic marking on the GPS terminal device moving along the road with the traffic marking;
(c) calculating a time of the GPS terminal device passing by an unit line of the traffic marking;
(d) computing a moving velocity according to the time and the unit line on the images; and
(e) generating the navigation display according to the map information and the moving velocity.

11. The navigation method as claimed in claim 10, wherein the traffic marking is a lane line.

12. The navigation method as claimed in claim 10, wherein the step (c) further comprises identifying at least one end point of the unit line of the images so as to calculate the time according to a starting time and an ending time.

13. The navigation method as claimed in claim 10, wherein the step (d) further comprises defining a length of the unit line according to markings and signals based upon the rule of regional traffic systems.

14. The navigation method as claimed in claim 10, wherein the step (d) further comprises defining a proportional scale with respect to the plurality of images so as to compute the moving velocity by a shifting length of the unit line on the images.
